(19) United States
(12) Patent Application Publication
(10) Pub. No.: US 2011/0083297 A1
(43) Pub. Date: Apr. 14, 2011

(54) Washer

(76) Inventor: Chang Hui Lin, Chang Hua Hsien (TW)

(21) Appl. No.: 12/587,945

(22) Filed: Oct. 14, 2009

(51) Int. Cl. F16L 5/00

(52) U.S. Cl. 16/2.1

(57) ABSTRACT

A washer includes a bore formed in an annular member, and one or more openings formed in the annular member for suitably decreasing the weight of the washer and for facilitating the contact and engagement between the washer and the other parts or elements for allowing the washer to be suitably and snugly or solidly engaged between the various parts or elements, the openings of the washer includes a shape selected from an oblong shape, a circular shape, a square shape, a pentagon shape, a hexagon shape, or a rhombus shape.

### BACKGROUND OF THE INVENTION

1. Field of the Invention

The present invention relates to a washer or gasket, and more particularly to a washer or gasket including a light weight structure for suitably decreasing the weight of the washer and for facilitating the contact and engagement between the washer and the other parts or elements.

2. Description of the Prior Art

Typical washers or gaskets comprise an annular or ring contour including a solid structure made of asbestos materials, graphite materials, metal materials, Teflon materials, rubber materials, porcelain materials, and attached or engaged between various parts or elements for suitably making a sealing between the parts or elements or for suitably filling the gaps between the parts or elements, and/or for suitably absorbing the shocks or vibrations between the parts or elements.

For example, U.S. Pat. No. 5,002,407 to Chi, and U.S. Pat. No. 5,181,437 to Chi disclose two of the typical bicycle hubs each also comprising one or more washers or gaskets provided and to be attached or engaged between various parts or elements for suitably making a sealing between the parts or elements.

U.S. Pat. No. 5,163,758 to Chi, and U.S. Pat. No. 6,302,589 to Van Houtte disclose two of the typical steering bearing devices for the bicycles each also comprising one or more washers or gaskets provided and to be attached or engaged between various parts or elements for suitably making a sealing between the parts or elements.

U.S. Pat. No. 5,507,476 to Lin discloses one of the typical shock absorbing devices for the bicycles also comprising one or more washers or gaskets provided and to be attached or engaged between various parts or elements for suitably making a sealing between the parts or elements.

U.S. Pat. No. 6,336,562 to Mori discloses one of the typical bicycle parking devices also comprising one or more washers or gaskets provided and to be attached or engaged between various parts or elements for suitably making a sealing between the parts or elements.

However, the typical washers or gaskets all include a solid structure which may include a great weight and which may also increases the weight of the bicycles or other facilities. In addition, the typical washers or gaskets all include a planar structure such that the typical washers or gaskets may not be suitably and snugly engaged between the various parts or elements.

The present invention has arisen to mitigate and/or obviate the afore-described disadvantages of the conventional washers or gaskets.

### SUMMARY OF THE INVENTION

The primary objective of the present invention is to provide a washer or gasket including a light weight structure for suitably decreasing the weight of the washer and for facilitating the contact and engagement between the washer and the various parts or elements.

In accordance with one aspect of the invention, there is provided a washer comprising a bore formed in an annular member, and one or more openings formed in the annular member for suitably decreasing the weight of the washer and for suitably increasing the friction between the washer and the other parts or elements, and for facilitating the contact and engagement between the washer and the other parts or elements for allowing the washer to be suitably and snugly or solidly engaged between the various parts or elements.

The openings of the washer includes a shape that may be selected from an oblong shape, a circular shape, a square shape, a pentagon shape, a hexagon shape, or a rhombus shape.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a washer or gasket in accordance with the present invention;

FIG. 2 is another plan schematic view similar to FIG. 1, illustrating the other arrangement of the washer or gasket;

FIG. 3 is a further plan schematic view similar to FIGS. 1 and 2, illustrating the further arrangement of the washer or gasket;

FIG. 4 is a still further plan schematic view similar to FIGS. 1-3, illustrating the still further arrangement of the washer or gasket;

FIG. 5 is a still further plan schematic view similar to FIGS. 1-4, illustrating the still further arrangement of the washer or gasket; and

FIG. 6 is a still further plan schematic view similar to FIGS. 1-5, illustrating the still further arrangement of the washer or gasket.

### DETAILED DESCRIPTION OF THE PREFERRED EMBODIMENT

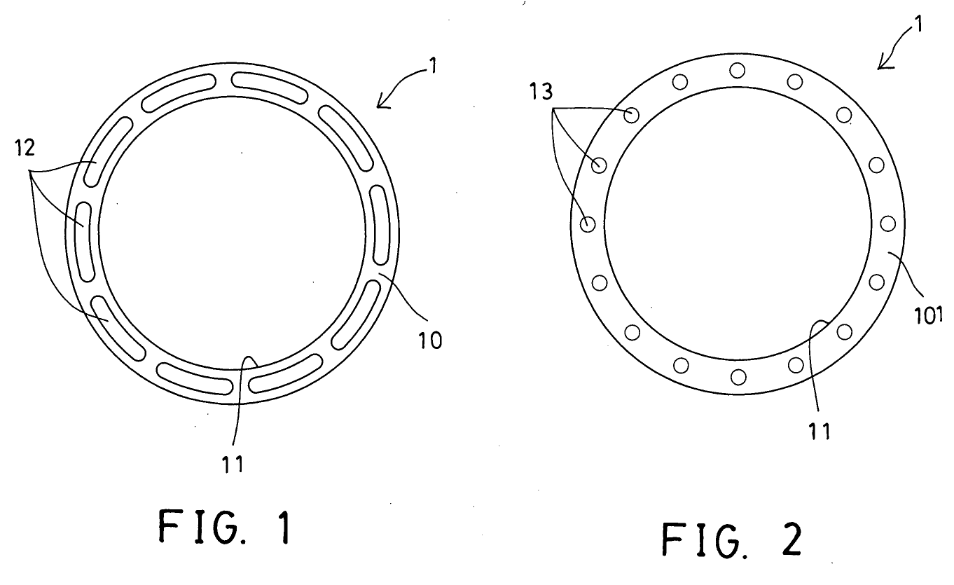

Referring to the drawings, and initially to FIG. 1, a washer 1 in accordance with the present invention comprises an annular or ring member 10 including a chamber or bore 11 formed therein, and including one or more openings 12 formed in the annular member 10 for suitably decreasing the weight of the washer 1 and for facilitating the contact and engagement between the washer 1 and the other parts or elements (not shown). It is to be noted that the formation or provision of the openings 12 in the annular member 10 may increase the friction between the washer 1 and the other parts or elements for allowing the washer 1 to be suitably and snugly or solidly engaged between the various parts or elements.

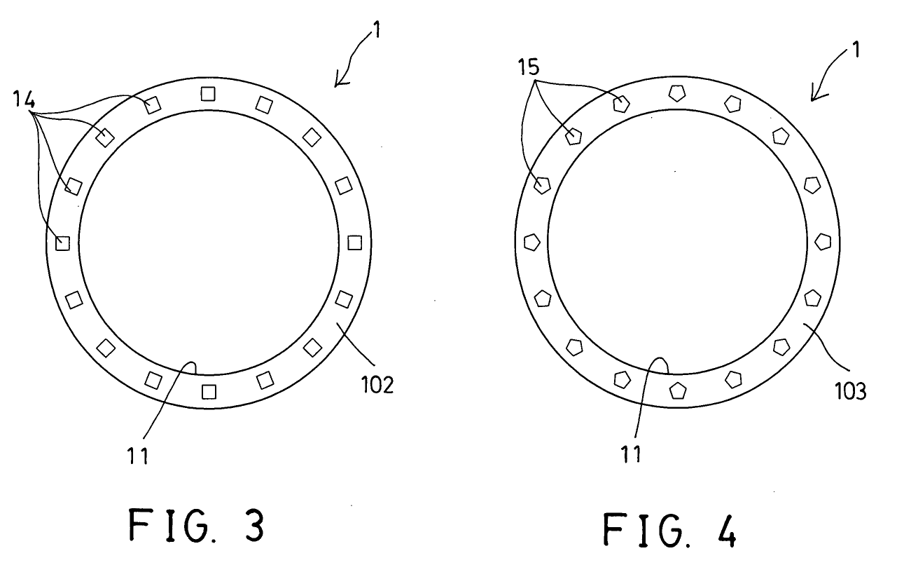

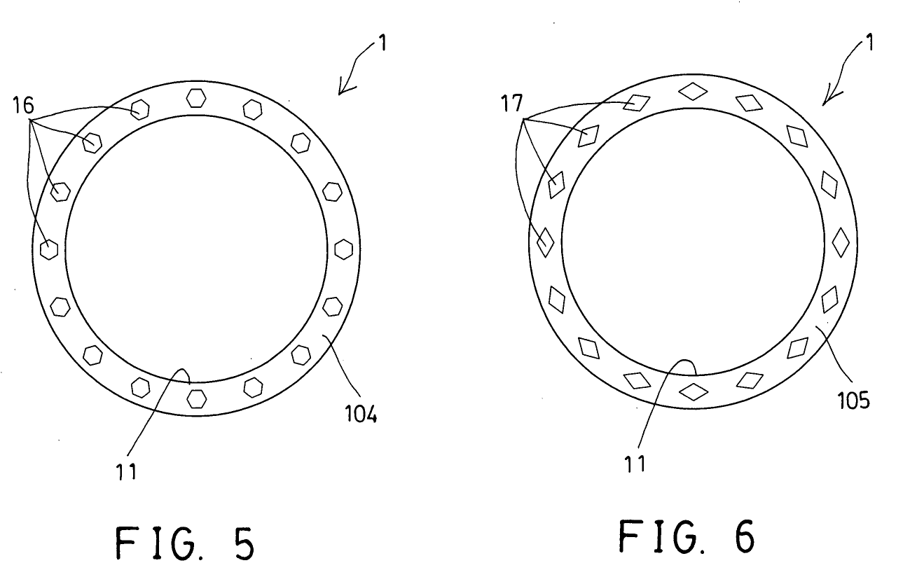

As also shown in FIG. 1, the openings 12 in the annular member 10 of the washer 1 may be formed into various shapes or contours or structures, such as the oblong shaped openings 12 formed in the annular member 10 as shown in FIG. 1, the circular shaped openings 13 formed in the annular member 101 as shown in FIG. 2, the square shaped openings 14 formed in the annular member 102 as shown in FIG. 3, the pentagonal shaped openings 15 formed in the annular member 103 as shown in FIG. 4, the hexagonal shaped openings 16 formed in the annular member 104 as shown in FIG. 5, or the rhomboid shaped openings 17 formed in the annular member 105 as shown in FIG. 6.

In operation, the formation or provision of the openings 12-17 in the annular members 10, 101-105 may suitably decrease the weight of the washer 1 and may increase the friction between the washer 1 and the other parts or elements for allowing the washer 1 to be suitably and snugly or solidly engaged between the various parts or elements. The gaskets or washers 1 may be made of various materials, such as asbestos materials, graphite materials, metal materials, Teflon materials, rubber materials, porcelain materials, or the like.

Accordingly, the washer in accordance with the present invention includes a light weight structure for suitably decreasing the weight of the washer and for facilitating the contact and engagement between the washer and the other parts or elements.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A washer comprising:
an annular member including a bore formed therein, and including at least one opening formed in said annular member for decreasing a weight of said washer.

2. The washer as claimed in claim 1, wherein said at least one opening of said washer includes a shape selected from an oblong shape, a circular shape, a square shape, a pentagon shape, a hexagon shape, or a rhombus shape.

3. A washer comprising:
an annular member including a bore formed therein, and including a plurality openings formed in said annular member for decreasing a weight of said washer.

4. The washer as claimed in claim 3, wherein said openings of said washer include a shape selected from an oblong shape, a circular shape, a square shape, a pentagon shape, a hexagon shape, or a rhombus shape.
